(19) United States
(12) Patent Application Publication
(10) Pub. No.: US 2021/0345016 A1
(43) Pub. Date: Nov. 4, 2021

(54) COMPUTER VISION BASED EXTRACTION AND OVERLAY FOR INSTRUCTIONAL AUGMENTED REALITY

(71) Applicant: Google LLC, Mountain View, CA (US)

(72) Inventors: Aiko Nakano, Mountain View, CA (US); Diane Wang, San Francisco, CA (US)

(21) Appl. No.: 15/929,472

(22) Filed: May 4, 2020

(51) Int. Cl. H04N 21/845; G06Q 30/06; H04N 21/43; H04N 21/81

(52) U.S. Cl. CPC H04N 21/8456; H04N 21/8153; H04N 21/4307; G06Q 30/0643

(57) ABSTRACT

Systems and methods are described that utilize one or more processors to obtain a plurality of segments of a first media content item, extract, from a first segment in the plurality of segments, a plurality of image frames associated with a plurality of tracked movements of at least one object represented in the extracted image frames, compare, objects represented in the image frames extracted from the first segment to tracked objects in a second media content item. In response to detecting that at least one of the tracked objects is similar to at least one object in the plurality of extracted image frames, generating virtual content depicting the plurality of tracked movements from the first segment being performed on the at least one tracked object in the second media content item and triggering rendering of the virtual content as an overlay on the at least one tracked object.

### TECHNICAL FIELD

This disclosure relates to Virtual Reality (VR) and/or Augmented Reality (AR) experiences and the use of computer vision to extract content.

### BACKGROUND

Users increasingly rely on digitally formatted content to learn new skills and techniques. However, when learning, it may be difficult to translate an instructor's physical world aspects to physical world aspects of a user accessing the digitally formatted content. For example, if an instructional video is shown for exercising a particular body type, it may be difficult for the user to translate the body part depicted in the digitally formatted content to the user's own body part in order to properly and safely carry out the exercise. Thus, improved techniques for providing instructional content within digitally formatted content may benefit a user attempting to apply techniques shown in such content.

### SUMMARY

The techniques described herein may provide an application that employs computer vision (CV) analysis to find instructional content in images and generate AR content for the instructional content. The AR content may be generated for being adapted to a shape or element in a specific content feed such that the AR content may be overlaid onto a user, an object, or other element in the content feed. The overlay of the AR content may function to assist users in learning new skills by viewing the AR content on the user, object or other element in the content feed. A content feed may be live, captured live, accessed online after capture, or accessed during the capture of the feed, but with a delay.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In a first general aspect, a computer-implemented method is described. The method is carried out by at least one processor, which may execute at least steps including obtaining a plurality of segments of a first media content item, extracting, from a first segment in the plurality of segments, a plurality of image frames, the plurality of image frames being associated with a plurality of tracked movements of at least one object represented in the extracted image frames, and comparing, objects represented in the image frames extracted from the first segment to tracked objects in a second media content item. In response to detecting that at least one of the tracked objects in the second media content item is similar to at least one object in the plurality of extracted image frames, the method may include generating, based on the extracted plurality of image frames, virtual content depicting the plurality of tracked movements from the first segment being performed on the at least one tracked object in the second media content item. The method may further include triggering rendering of the virtual content as an overlay on the at least one tracked object in the second media content item.

Particular implementations of the computer-implemented method may include any or all of the following features. In some implementations, the method may use one or more image capture devices. The method may include extracting, from the plurality of segments, a second segment from the first media content item, the second segment having a timestamp after the first segment and generating, using the extracted at least one image frame from the second segment of the first media content item, virtual content that depicts the at least one image frame from the second segment on the at least one tracked object in the second media content item. In some implementations, the at least one image frame from the second segment depicts a visual result associated with the at least one object in the extracted image frames.

In some implementations, a computer vision system is employed by the at least one processor to analyze the first media content item to determine which of the plurality of segments to extract and which of the plurality of image frames to extract and to analyze the second media content item to determine which object corresponds to the at least one object in the plurality of extracted image frames of the first media content item.

In some implementations, detecting that the at least one tracked object in the second media content item is similar to the at least one object in the plurality of extracted image frames includes comparing a shape of the at least one tracked object to the shape of the at least one object in the plurality of extracted image frames. In some implementations, the generated virtual content is depicted on the at least one tracked object according to the shape of the at least one object in the plurality of extracted image frames. In some implementations, triggering rendering of the virtual content as an overlay on the at least one tracked object in the second media content item includes synchronizing the rendering of the virtual content on the second media content item with a timestamp associated with the first segment.

In some implementations, the plurality of tracked movements correspond to instructional content in the first media content item and the plurality of tracked movements are depicted as the virtual content, the virtual content illustrating performance of the plurality of tracked movements on the at least one object in the plurality of extracted image frames in the second media content item.

In some implementations, the plurality of tracked movements correspond to instructional content in the first media content item and the plurality of tracked movements are depicted as the virtual content. The virtual content may illustrate performance of the plurality of tracked movements on the at least one object in the plurality of extracted image frames in the second media content item.

Implementations of the described techniques may include systems, hardware, a method or process, and/or computer software on a computer-accessible medium. The details of one or more implementations are set forth in the accompanying drawings and the description below. Other features will be apparent from the description and drawings, and from the claims.

### BRIEF DESCRIPTION OF THE DRAWINGS

FIG. 1 illustrates an example of instructional content accessed by a user utilizing an example electronic device, according to example implementations.

FIG. 2 is a block diagram of an example computing device with framework for extracting and modifying instructional content for overlay onto image content presented in an AR experience, according to example implementations.

FIGS. 3A-3D depict an example illustrating extraction and modification of instructional content for overlay onto live image content presented in an AR experience, according to example implementations.

FIGS. 4A-4B depict another example illustrating extraction and modification of instructional content for overlay onto live image content presented in an AR experience, according to example implementations.

FIGS. 5A-5B depict yet another example illustrating extraction and modification of instructional content for overlay onto live image content presented in an AR experience, according to example implementations.

FIG. 6 is an example process to analyze image content for use in generating layered augmented reality content, according to example implementations.

FIG. 7 illustrates an example of a computer device and a mobile computer device, which may be used with the techniques described herein.

The use of similar or identical reference numbers in the various drawings is intended to indicate the presence of a similar or identical element or feature.

### DETAILED DESCRIPTION

This disclosure relates to Virtual Reality (VR) and/or Augmented Reality (AR) experiences and the use of computer vision (CV) techniques to enable users to view and experience immersive media content items (e.g., instructional content including, but not limited to images, image frames, videos, video clips, video or image segments, etc.). For example, the CV techniques may detect, analyze, modify, and overlay AR content (representing instructional video content) onto an image/video feed belonging to a user to visually assist the user in carrying out instructions from the instructional video.

The techniques described herein may provide an application that employs CV analysis to find instructional content in images and generate AR content for the instructional content. The AR content may be generated for being adapted to a shape or element in a specific live feed such that the AR content may be overlaid onto a user, an object, or other element in the live feed. The overlay of the AR content may function to assist users in learning new skills by viewing the AR content on the user, object or other element in the live feed recognized by the user.

The techniques described herein may provide an advantage of improved learning, because the systems described herein can adapt and fit an AR overlay representing the instructional video content onto video and/or images of a user attempting to carry out the instructions of the instructional video, which can help guide the user using elements captured in the video and/or images of the user (and/or content/objects with which the user is interacting). In some implementations, the instructional content may be adapted to video and/or images of the user accessing the instructional content to improve user learning while providing product information and shopping opportunities related to products and content in the instructional content.

The systems and methods described herein leverage CV techniques to extract, modify, and overlay AR content (e.g., user interface (UI) elements, virtual objects, brushstrokes, etc.) onto image content. The overlaid AR content may provide the advantage of improved understanding of instructional content by providing visual instructions (e.g., content, motions, movement, etc.) that pertain to a specific user accessing the instructional content. For example, the systems and methods described herein may employ CV technology to extract instructional content (e.g., image frames, objects, movements, etc.) from a video.

In some implementations, image frames from the instructional content in the video can be preprocessed, and objects within the content may be tracked to identify relevant visual steps from the instructions provided in the video. Segmentation techniques may then be applied to extract such objects (or portions of the objects) for use in generating AR content and objects to be depicted (e.g., overlaid) on a camera feed associated with the user accessing the instructional content on an electronic device, for example.

In some implementations, the image frames from the instructional content can be processed during play (e.g., live streaming, streaming, online access), and objects within the content may be tracked to identify visual steps from the instructions. Such image frames may be provided as AR content overlaid onto a live feed of a user carrying out the instructions of the instructional content (e.g., video).

In some implementations, the CV techniques employed by the systems and methods described herein can detect and/or otherwise assess movements carried out in an instructional video and results of such movements can be extracted, modified, and overlaid onto a live feed of a user carrying out the instructions on elements (e.g., face, craft project, body part, etc.) shown in the live feed. In a non-limiting example, an instructional video showing how to shape an eyebrow may be executing on an electronic device while a camera of such a device captures an image (e.g., live feed) of the user operating the electronic device. The visually instructional portions (e.g., brush strokes, makeup application, etc.) of the instructional video may be extracted and modified so that such portions can be overlaid to appear as if the instructions are being carried out on the eyebrow of the user in the live feed.

In such an example, the systems and methods described herein may determine how to modify the extracted content by analyzing content in the instructional video and content in a video feed. For example, the systems and methods described herein may assess the shape of the eye, facial features, and/or eyebrow in both the instructional video and the shape of the eye and/or eyebrow of the user in the live feed. The assessment may apply one or more algorithms to ensure the outcome of the eyebrow on the live feed follows guidelines of shaping eyebrows for a particular eye shape, facial feature, shape, etc. For example, the instructional video may ensure that the shaping and makeup application on the eyebrow begins at a starting point associated with an inner eye location and ends at an ending point associated with an outer eye location. Such locations may be mapped to fit the shape of the eye, eyebrow, face, etc., of the user in the live feed such that the look (e.g., shape, color, movement) in the instructional video is appropriately fitted to the images of the user in the live feed. Such assessment may ensure that the user is provided a realistic approach to eyebrow shaping and associated makeup application for the eyebrow belonging to the user in the live feed. The instructions can also include providing feedback and if the user is not following the instructions properly, the systems and methods described herein can provide specific instructions on how to modify what the user is doing via textual or visual feedback.

In some implementations, the techniques described herein can be used to provide AR content to assist with instructional content for makeup application. For example, CV and object tracking can be used to detect and track movement of makeup tools and to segment makeup around the object (e.g., an eye, face, lips, etc.). For example, the techniques described herein can identify an eye category or area within an instructional video upon identifying that an eye liner tool in the instructional video is the object that is moving at a high threshold level (i.e., more than other objects in the video). Upon identifying the eye liner tool is moving, the techniques can extract the path (e.g., brushstroke) of the eye liner tool. The extracted path may be modified to appropriately fit the eye liner application to an eye of the user, which is captured in a camera feed directed at the face of the user.

After particular relevant content is extracted using CV techniques, the content may be applied to the live feed as augmented reality (AR) content. For example, the content may be morphed to properly to fit an object in the user's live feed. For example, the eyebrow shaping path may be extracted from an instructor's face mesh in the instructional video and modified to fit the user's face parts shape in AR. In some implementations, additional UI content may be displayed. For example, an AR application may display a dot element on top of makeup content to highlight particular instructions such as a brushstroke path, a current position of the brush, and the like. Additional elements including motion paths, joint positioning, and/or other instructional content can be provided as AR content overlaid onto the live feed.

A number of extraction methodologies and content segmentation techniques may be employed and thus scale of generated content (e.g., using face mesh analysis, body pose analysis, optical flow techniques, etc.) may vary depending on different types of instructional content. Similar extraction and content segmentation techniques may be applied to other instructional content examples including, but not limited to crafts, exercise, sports, interior design, repair, hobbies, and/or other accessible instructional content.

In some implementations, the systems and methods described herein may utilize machine learning models with the CV techniques to improve tracking and segmentation results. Machine learning models that utilize neural networks may receive images as input in order to provide any number of types of output. One such example output includes image classification, in which the machine learning model is trained to indicate a class associated with an object in an image. Another example includes object detection in which the machine learning model is trained to output the specific location of an object in the image. Yet another example includes the class of image to image translation, in which the input is an image and the output is a stylized version of the original input image. Other examples can include, but are not limited to, facial feature tracking and segmentation for Augmented Reality (AR) (e.g., localizing 2D facial features from an input image or video), facial mesh generation for AR (e.g., inferring a 3D face mesh from an input image or video), hand, body, and/or pose tracking, and lighting estimation for AR (e.g., estimating scene illumination from an input image to use for realistically rendering virtual assets into the image or video feed), and translation (text on screen for product names, instructions, translation, etc.). In some implementations, instructional content may be improved by audio inputs using speech-to-text algorithms.

In general, the techniques described herein may provide an application to find relevant content in an instructional content video and to experience the relevant content in an immersive way. Particular implementations may utilize computer vision (CV) based techniques to extract an instructional content (e.g., tutorials, instructions, movements, etc.). The content may be associated with a particular timestamp from a video depicting the instructional content. The extracted content may be overlaid onto a live camera feed belonging to a user operating a device streaming (e.g., executing) the instructional media content items (e.g., video, clips, segments, images, frames, etc.). The overlay may provide instructional guidance to the user on the live feed.

In some implementations, an object tracker is used to identify a relevant step in the instructional content. The object tracker uses an optical flow CV technique to track the relevant step. In some implementations, relevant content (e.g., makeup texture) may be extracted using segmentation techniques. The extracted content may be morphed (using face mesh algorithms, body mesh algorithms) before being overlaid onto a live camera feed. In some implementations, the extraction is pre-processed and uses a fixed number of frames in the instructional content video (e.g., before and after the current timestamp).

After the relevant content is extracted using computer vision, the content is applied to the live camera feed in AR. For example, an eyeliner path may be extracted from the instructor's face mesh in the instructional video, which may be modified to fit particular face portions (or shapes) belonging to the user in the live feed. In some implementations, the extraction is performed real time and applied as AR content to the user of the live feed in near real time.

In some implementations, the techniques described herein may also use additional UI element(s) along with the extracted content to highlight the instructions. For example, a location dot element may be used on top of the makeup content to highlight the instructions, which may show a particular brushstroke path, current position of the brush, etc. In the case of sports-based instructional video, the AR experience may utilize such additional UI elements to instruct motion paths and proper joint positions to teach the user in the live feed to properly carry out instructions.

In some implementations, particular extracted frames from the instructional content may be preprocessed. Such preprocessing may include the user of a vision service and/or Optical Code Recognition (OCR) to enable the systems described herein to determine and suggest a particular product or other instructional content.

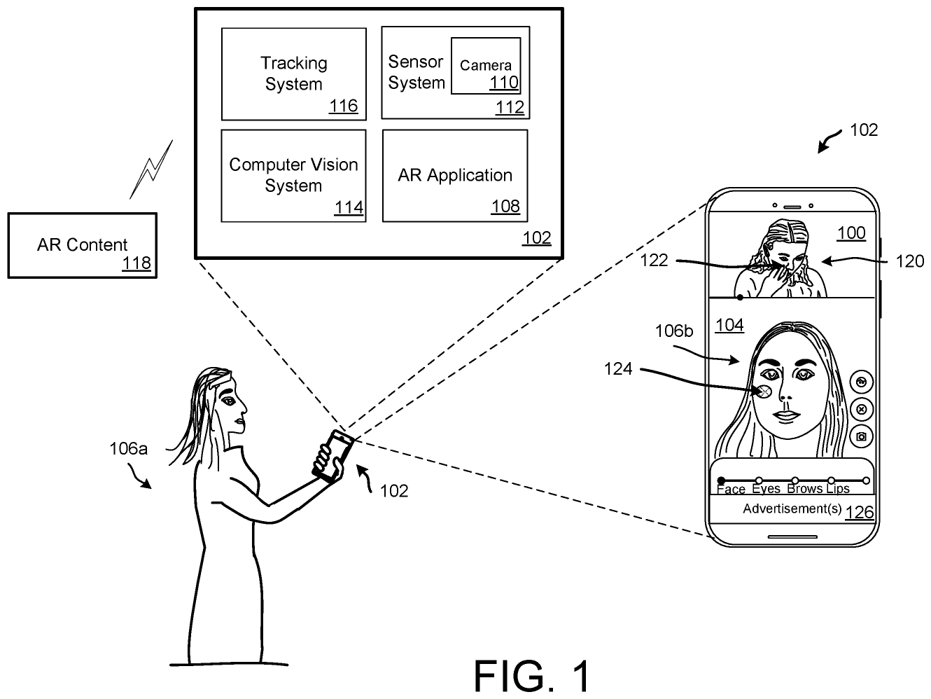

FIG. 1 illustrates an example media content item 100 accessed by an example electronic device 102, according to example implementations. The electronic device 102 is depicting an instructional video (e.g., content item 100) and a live feed 104 (e.g., a live video feed) of a user 106 (shown as user 106a and captured user 106b). Here, the user 106a may use device 102 to capture live feed 104 from a front-facing camera of the electronic device 102. In some implementations, the live feed may be provided by a rear-facing camera and/or otherwise within an AR application 108.

In this example, the user 106a may access a camera 110 in sensor system 112, computer vision (CV) system 114, and tracking system 116, which may work together to provide software and algorithms that track, generate, and place AR content around captured image feed 104 (e.g., live and real time). For example, the computing device 102 can detect that instructional content item 100 is being accessed and that the user is capturing a feed 104. In some implementations, computations can be done in the cloud (e.g., pre-processed or live computer vision algorithm on video and camera feed, etc.) where the device is used to render content. Both content 100 and feed 104 may be depicted on device 102 to allow the user to learn the instructional content 100 using the face belonging to the user (106a), as shown by captured user face 106b, in this example. The device 102 may include or have access to a computer vision system 114, which can detect elements, objects, or other details in content item 100 and/or feed 104. The detected elements may represent portions of content item 100 to be modified for use in generating AR content 118, which may be overlaid onto feed 104. Tracking system 116 can assist the computer vision system 114 to extract and modify particular content 100. AR application 108 may assist in modifying and rendering AR content 118 on device 102.

For example, the computing device 102 can detect (or be provided with indications) that instructional content item 100 is being accessed and that the user 106a is capturing the feed 104. Both content 100 and feed 104 may be depicted on device 102 to allow the user to learn the instructional content 100 on the face belonging to the user (106a), as shown by captured user face 106b, in this example. Here, the instructional content 122 includes the user 120 applying makeup to her cheek, as shown by moving hands near the cheek of user 120. The device 102 may include or have access to the computer vision system 114, which can detect the instructional content 122 (e.g., actions, movements, color application, modification of objects, facial features, etc.) or other details in content item 100. The instructional content (e.g., makeup application movements) and resulting output of such content (e.g., makeup color application on the cheek of user 120) may be detected, extracted, and/or otherwise analyzed. In some implementations, the instructional content and resulting output can be modified (e.g., segmented, morphed, etc.) to be properly aligned to portions of the live feed 104. In this example, the instructional content and resulting output can be tracked with respect to movements (e.g., fingers/brush applying blush) and may then be modified for placement (as AR content) on the cheek of user 106b, as shown by blush content 124 in live feed 104. The AR content may be applied using the same motions of the instructional content using the tracked movements from the instructional content. In this example, finger-based application of cheek color can be simulated to appear over time as if the cheek color is being applied to the user 106b in the same fashion as in the instructional content. The resulting AR content 124 may appear in a determined location corresponding to the location of user 120, as retrieved from a face location of user 120, shown by content 122.

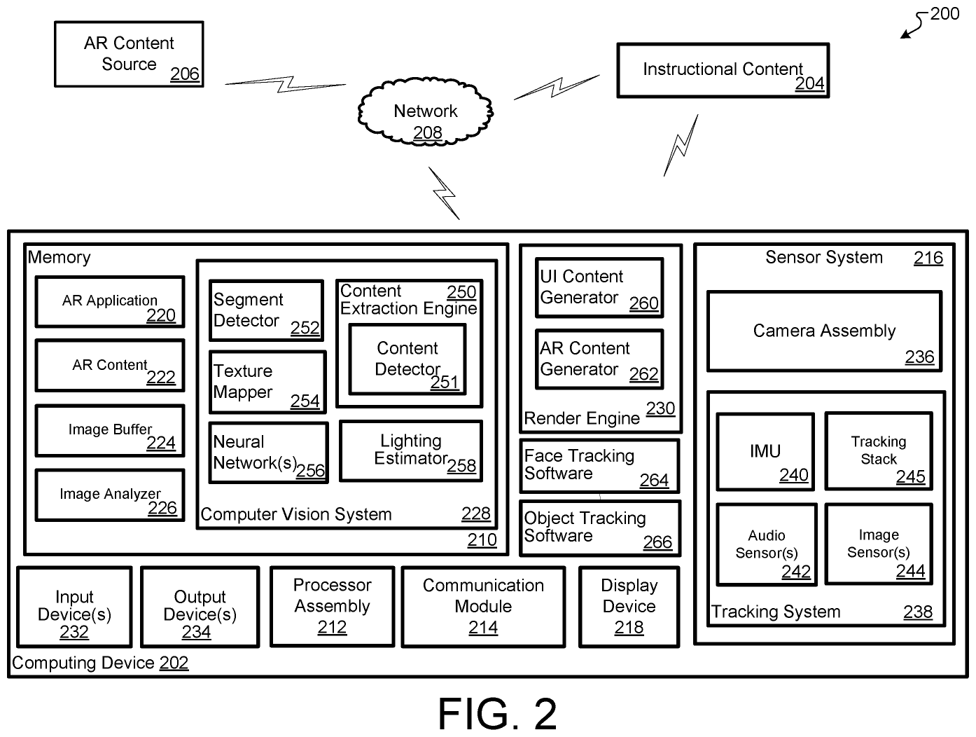

FIG. 2 is a block diagram of an example computing device 202 with framework for extracting and modifying instructional content for overlay onto image content presented in an AR experience, according to example implementations. In some implementations, the framework may extract image content from media content items (e.g., images, image frames, videos, video clips, video or image segments, etc.) for use in generating virtual content for presentation in the AR experience. In some implementations, the framework may be used to generate virtual content that may be overlaid onto other media content items (e.g., a live feed of a user) to provide an AR experience that assists the user in learning how to apply instructional content from the media content item to a face, an object, or other element captured in the live feed of the user.

In operation, the system 200 provides a mechanism to use CV to determine how to modify extracted content by analyzing content in instructional images or videos and content in a live (video) feed. In some implementations, the system 200 may use machine learning to generate virtual content from extracted content from such instructional images or videos. The virtual content may be overlaid onto a live video feed. In some implementations, the system 200 may also use machine learning to estimate high dynamic range (HDR) lighting and/or illumination for lighting and rendering the virtual content into the live feed.

As shown in FIG. 2, the computing device 202 may receive and/or access instructional content 204 via network 208, for example. The computing device 202 may also receive or otherwise access virtual content from AR content source 206 via network 208, for example.

The example computing device 202 includes memory 210, a processor assembly 212, a communication module 214, a sensor system 216, and a display device 218. The memory 210 may include an AR application 220, AR content 222, an image buffer 224, an image analyzer 226, a computer vision system 228, and a render engine 230. The computing device 202 may also include various user input devices 232 such as one or more controllers that communicate with the computing device 202 using a wireless communications protocol. In some implementations, the input device 232 may include, for example, a touch input device that can receive tactile user inputs, a microphone that can receive audible user inputs, and the like. The computing device 202 may also one or more output devices 234. The output devices 234 may include, for example, a display for visual output, a speaker for audio output, and the like.

The computing device 202 may also include any number of sensors and/or devices in sensor system 216. For example, the sensor system 216 may include a camera assembly 236 and a 3-DoF and/or 6-DoF tracking system 238. The tracking system 238 may include (or have access to), for example, light sensors (not shown), inertial measurement unit (IMU) sensors 240, audio sensors 242, image sensors 244, distance/proximity sensors (not shown), positional sensors (not shown), haptic sensors (not shown), and/or other sensors and/or different combination(s) of sensors. Some of the sensors included in the sensor system 216 may provide for positional detection and tracking of the device 202. Some of the sensors of system 216 may provide for the capture of images of the physical environment for display on a component of a user interface rendering the AR application 220. Some of the sensors included in sensor system 216 may track content within instructional content 204 and or one or more image and/or video feeds captured by camera assembly 236. Tracking content within both instructional content 204 (e.g., a first media content item) and feeds (e.g., a second content item) captured by assembly 236 may provide a basis for correlating objects between the two media content items for purposes of generating additional content to assist the user in learning how to carry out instructions from the instructional content 204.

The computing device 202 may also include a tracking stack 245. The tracking stack 245 may represent movement changes over time for a computing device and/or for an AR session. In some implementations, the tracking stack 245 may include the IMU sensor 240 (etc. gyroscopes, accelerometers, magnetometers). In some implementations, the tracking stack 245 may perform image-feature movement detection. For example, the tracking stack 245 may be used to detect motion by tracking features (e.g., objects) in an image or number of images. For example, an image may include or be associated with a number of trackable features that may be tracked from frame to frame in a video including the image (or number of images), for example. Camera calibration parameters (e.g., a projection matrix) are typically known as part of an onboard device camera and thus, the tracking stack 245 may use image feature movement along with the other sensors to detect motion and changes within the image(s). The detected motion may be used to generate virtual content (e.g., AR content) using the images to fit an overlay of such images onto a live feed from camera assembly 236, for example. In some implementations, the original images, and/or the AR content may be provided to neural networks 256, which may use such images and/or content to further learn and provide lighting, additional tracking, or other image changes. The output of such neural networks may be used to train AR application 220, for example, to accurately generate and render particular AR content onto live feeds.

As shown in FIG. 2, the computer vision system 228 includes a content extraction engine 250, a segment detector 252, and a texture mapper 254. The content extraction engine 250 may include a content detector 251 to analyze content within media content items (e.g., image frames, images, video, etc.) and identify particular content or content areas of the media content items in which to extract. For example, the content extraction engine may employ computer vision algorithms to identify features (e.g., objects) within particular image frames and may determine relative changes in features (e.g., objects) in the image frames relative to similar features (e.g., objects) in another set of image frames (e.g., another media content item). In some implementations, the content extraction engine 250 may recognize features and/or changes in such features between two media content items and may extract portions of a first media content item in order to enable render engine 230 to render content from the first media content item over objects and/or content in a second media content item.

Similarity may be based on performing computer vision analysis (using system 228) on both a first media content item and a second content item. The analysis may compare particular content including, but not limited to objects, tracked objects, object shapes, movements, tracked movements, etc. to determine at least a portion of similarity between such content. For example, an eye may be detected in a first media content item while another eye may be detected in a second media content item. The similarity may be used to apply movements being shown near the eye in the first media content item as an overlay in the eye in the second media content item to mimic a result from the first media content item in the second media content item.

In some implementations, the computer vision system 228 may perform multiple passes of CV algorithms (e.g., techniques). In an example media content item (e.g., video), the computer vision system 228 may perform a first pass to assess areas of the video that include moving elements. For example, the computer vision system 228 may detect movement in an area where a makeup brush is moving over a face of the user. Such an area may be extracted for further processing. For example, the computer vision system 228 may perform the further processing by performing a second pass of the extracted content to target an area in which the makeup tool is working upon. The targeted area in this example may include an eyeliner path and as such, the system 228 may extract the eyeliner path for application as an overlay on another video showing a live feed of a user, for example. In some implementations, the computer vision system 228 may be used on a digital model in which a content author generates media content items using digital models instead of using themselves as the model in the media content item (e.g., video). The system 228 may extract the content and movements applied to the digital model for use as an overlay on another video showing a live feed of a user, for example.

The content detector 251 may identify particular edges, bounding boxes, or other portions within media content items (e.g., within image frames of media content items). For example, the content detector 251 may identify all or a portion of edges of elements (e.g., features, objects, face portions, tools, body portions, etc.) within a particular image frame (or set of image frames). In some implementations, the content detector 251 may identify edges of a tool being used in the content item (or identify bounding boxes around such tools) in order to determine that the edges (or bounded tool) represent particular unique images for a given location (e.g., a reference position for using a painting tool). In some implementations, the identified edges and bounding boxes may be provided by an author of a particular content item using timestamps, reference positions, and/or other location representation for identifying content in a media content item. In some implementations, the content detector 251 may identify features within media content items. The features may be detected when segments of the media content items are provided as part of a process to place virtual content (e.g., VR content, AR content) onto objects identified within additional media content items.

In some implementations, the content detector 251 may use landmark detection techniques, face mesh overlay techniques (e.g., using feature points), masking techniques, and mesh blending techniques to detect and extract particular content from media content items.

The segment detector 252 may detect video segments within media content items. In some implementations, the segment detector 252 may be configured to detect preconfigured segments generated by a media content item author. For example, a user that generates instructional media content items may preconfigure (e.g., label, group, etc.) segments of the content item (e.g., video). The segment detector 252 may use the preconfigured segments to perform comparisons between segments of a first content item and objects in other content items. In some implementations, the segment detector 252 may generate sectors using content detector 251, for example.

In some implementations, the texture mapper 254 may be used to extract texture (rather than a full face mesh) from particular image frames, objects, etc. The texture mapper 254 may define image detail, surface texture, and/or color information onto three dimensional AR objects, for example. Such content may be mapped and used as an overlay onto objects within a media content item.

In some implementations, the computer vision system 228 also includes a lighting estimator 258 with access to neural networks 256. The lighting estimator 258 may include or have access to texture mapper 254 in order to provide proper lighting for the virtual content (e.g., VR and/or AR content) being overlaid onto objects or features within media content items. In some implementations, the lighting estimator 258 may be used to generate lighting estimations for an AR environment. In general, the computing device 202 can generate the lighting conditions to illuminate content which may be overlaid on objects in a media content item. In addition, the device 202 can generate the AR environment for a user of the system 200 to trigger rendering of the AR scene with the generated lighting conditions on device 202, or another device. Lighting estimator can be used to remove lighting information and extract material information from the original content to be applied properly as the AR content overlaid on top of the camera feed.

As shown in FIG. 2, the render engine 230 includes a UI content generator 260 and an AR content generator 262. The UI content generator 260 may use extracted content (e.g., from engine 250) to generate and/or modify image frames representing the extracted content. Such image frames may be used by AR content generator 262 to generate the AR content for overlay onto objects within media content items. In some implementations, the UI content generator 260 may generate elements to display advertising and purchasing options for products that are described within instructional content 204, for example. In some implementations, the UI content generator 260 may additionally generate suggestions for additional media content items related to particular accessed media, instructional content, and/or products.

The computing device 202 may also include face tracking software 264. The face tracking software 264 may include (or have access to) one or more face cue detectors (not shown), smoothing algorithms, pose detection algorithms, computer vision algorithms (via computer vision system 228), optical flow algorithms, and/or neural networks 256. The face cue detectors may operate on or with one or more cameras assemblies 236 to determine a movement in the position of particular facial features, head, or body of the user. For example, the face tracking software 264 may detect or obtain an initial three-dimensional (3D) position of computing device 202 in relation to facial features or body features (e.g., image features) captured by the one or more camera assemblies 236. In some implementations, one or more camera assemblies 236 may function with software 264 to retrieve particular facial features captured in a live feed, for example, by camera assemblies 236 in order to enable placement of AR content upon the facial features captured in the live feed. In addition, the tracking system 238 may access the onboard IMU sensor 240 to detect or obtain an initial orientation associated with the computing device 202, if for example, the user is moving (or moving the device 202) during capture.

The computing device 202 may also include object tracking software 266. The object tracking software 266 may include (or have access to) one or more object detectors (e.g., object trackers, not shown), smoothing algorithms, pose detection algorithms, computer vision algorithms (via computer vision system 228), optical flow algorithms, and/or neural networks 256. The object detectors may operate on or with one or more cameras assemblies 236 to determine a movement in the position of particular objects within a scene. For example, the object tracking software 266 may detect or obtain an initial three-dimensional (3D) position of computing device 202 in relation to objects (e.g., image features) captured by the one or more camera assemblies 236. In some implementations, one or more camera assemblies 236 may function with software 266 to retrieve particular object features captured in a live feed, for example, by camera assemblies 236 in order to enable placement of AR content upon the tracked objects captured in the live feed.

In some implementations, the computing device 202 is a mobile computing device (e.g., a cellular device, a tablet, a laptop, an HMD device, AR glasses, a smart watch, smart display, etc.) which may be configured to provide or output AR content to a user via the device and/or via an HMD device.

The memory 210 can include one or more non-transitory computer-readable storage media. The memory 210 may store instructions and data that are usable to generate an AR environment for a user.

The processor assembly 212 includes one or more devices that are capable of executing instructions, such as instructions stored by the memory 210, to perform various tasks associated with the systems and methods described herein. For example, the processor assembly 212 may include a central processing unit (CPU) and/or a graphics processor unit (GPU). For example, if a GPU is present, some image/video rendering tasks, such as shading content based on determined lighting parameters, may be offloaded from the CPU to the GPU.

The communication module 214 includes one or more devices for communicating with other computing devices, such as the instructional content 204 and the AR content source 206. The communication module 214 may communicate via wireless or wired networks, such as the network 208.

The IMU 240 detects motion, movement, and/or acceleration of the computing device 202 and/or the HMD. The IMU 240 may include various different types of sensors such as, for example, an accelerometer, a gyroscope, a magnetometer, and other such sensors. A position and orientation of the device 202 may be detected and tracked based on data provided by the sensors included in the IMU 240. The detected position and orientation of the device 202 may allow the system to in turn, detect and track the user's gaze direction and head movement. Such tracking may be added to a tracking stack 245 that may be polled by the computer vision system 228 to determine changes in device and/or user movement and to correlate times associated to such changes in movement. In some implementations, the AR application 220 may use the sensor system 216 to determine a location and orientation of a user within a physical space and/or to recognize features or objects within the physical space.

The camera assembly 236 captures images and/or videos of the physical space around the computing device 202. The camera assembly 236 may include one or more cameras. The camera assembly 236 may also include an infrared camera or time of flight sensors (e.g., used to capture depth).

The AR application 220 may present or provide virtual content (e.g., AR content) to a user via the device 202 and/or one or more output devices 234 of the computing device 202 such as the display device 218, speakers (e.g., using audio sensors 242), and/or other output devices (not shown). In some implementations, the AR application 220 includes instructions stored in the memory 210 that, when executed by the processor assembly 212, cause the processor assembly 212 to perform the operations described herein. For example, the AR application 220 may generate and present an AR environment to the user based on, for example, AR content 222 (e.g., AR content 124), and/or AR content received from the AR content source 206.

In some implementations, advertisement content 126 may be provided to the user. Such content 126 may include UI content that includes products accessed in item 100, media content items related to particular accessed media content item 100, instructional content, and/or related products. In some implementations, the system 200 may use computer vision system 228 or speech-to-text technology (if the content creator mentions them in the video) to automatically detect which products are used within a particular instructional content 204. The automatically detected products can be used as input to a search to generate advertisement content for display to users accessing the instructional content 204. This may provide an advantage of allowing the content item author to automatically embed (or otherwise provide) advertising content and informational content for products being used without having to manually provide the information alongside (or within) the executing content item

The AR content 222 herein may include AR, VR, and/or mixed reality (MR) content such as images or videos that may be displayed on a display 218 associated with the computing device 202, or other display device (not shown). For example, the AR content 222 may be generated with instructional content, UI content, lighting (using lighting estimator 258) that substantially matches the physical space in which the user is located. The AR content 222 may include objects that overlay various portions of the physical space. The AR content 222 may be rendered as flat images or as three-dimensional (3D) objects. The 3D objects may include one or more objects represented as polygonal meshes. The polygonal meshes may be associated with various surface textures, such as colors and images. The polygonal meshes may be shaded based on various lighting and/or texture parameters generated by the AR content source 206 and/or computer vision system 228 and/or render engine 230.

In some implementations, a number of mesh algorithms may be used including, but not limited to face alignment techniques including facial landmark detection (e.g., Haar Cascade Face Detector or Dlib using Histogram of Oriented number of Gradients (HOG)-based Face Detector), finding convex hull, Delaunay triangulation, and affine warp triangles. In some implementations, seamless cloning can be used to extract, morph, and overlay content from the video onto a camera feed. Semantic segmentation can be used to extract objects from the video content. In some implementations, a neural network approach can be used using autoencoders to extract and apply content. In addition, machine learning approaches may be used to interpolate and approximate the mesh when a frame in the original video is not sufficient to extrapolate mesh. For example, if a person looked away or down for one second and the mesh extraction algorithm was not able to detect a human face in the frame, the preceding and succeeding frames can be used to estimate the mesh at that point in the instructions.

The AR application 220 may use the image buffer 224, image analyzer 226, lighting estimator 258, and render engine 230 to generate images for display based on the AR content 222. For example, one or more images captured by the camera assembly 236 may be stored in the image buffer 224. The AR application 220 may use the computer vision system 228 to determine a location within a media content item in which to insert content. For example, the AR application 220 may determine a tracked object in which to overlay the AR content 222. In some implementations, the location may also be determined based on a location that was determined for the content in a previous image captured by the camera assembly (e.g., the AR application 220 may cause the content to move across a surface in that was identified within the physical space captured in the image).

The image analyzer 226 may then identify a region of the image stored in the image buffer 224 based on the determined location. The image analyzer 226 may determine one or more properties, such as texture, depth, brightness (or luminosity), hue, and saturation, of the region. In some implementations, the image analyzer 226 filters the image to determine such properties. For example, the image analyzer 226 may apply a mipmap filter (e.g., a trilinear mipmap filter) to the image to generate a sequence of lower-resolution representations of the image. The image analyzer 226 may identify a lower resolution representation of the image in which a single pixel or a small number of pixels correspond to the region. The properties of the region can then be determined from the single pixel or the small number of pixels. The lighting estimator 258 may then generate one or more light sources or environmental light maps based on the determined properties. The light sources or environmental light maps can be used by the render engine 230 to render the inserted content or an augmented image that includes the inserted content in the media content item.

In some implementations, the image buffer 224 is a region of the memory 210 that is configured to store one or more images. In some implementations, the computing device 202 stores images captured by the camera assembly 236 as a texture within the image buffer 224. Alternatively, or additionally, the image buffer 224 may also include a memory location that is integral with the processor assembly 212, such as dedicated random access memory (RAM) on a GPU.

In some implementations, the image analyzer 226, the computer vision system 228, the lighting estimator 258, and render engine 230 may include instructions stored in the memory 210 that, when executed by the processor assembly 212, cause the processor assembly 212 to perform operations described herein to generate an image or series images that are displayed to the user and represent instructional AR content that is illuminated using lighting characteristics that are calculated using the neural networks 256 described herein.

The system 200 may include (or have access to) one or more neural networks 256. The neural networks 256 may utilize an internal state (e.g., memory) to process sequences of inputs, such as a sequence of a user moving and changing a location when in an AR experience. In some implementations, the neural networks 256 may utilize memory to process images (e.g., media content items), computer vision aspects, and lighting aspects and to generate lighting estimates for an AR experience.

The neural networks 256 may include detectors that operate on images to compute, for example, lighting estimates and/or face locations to model predicted lighting and/or locations of the face as the face/user moves in world space. In addition, the neural networks 256 may operate to compute lighting estimates and/or face locations several timesteps into the future. The neural networks 256 may include detectors that operate on images to compute, for example, device locations and lighting variables to model predicted lighting for a scene based on device orientation, for example.

The AR content source 206 may generate and output AR content, which may be distributed or sent to one or more computing devices, such as the computing device 202, via the network 208. In some implementations, the AR content 222 includes three-dimensional scenes and/or images. Additionally, the AR content 222 may include audio/video signals that are streamed or distributed to one or more computing devices. The AR content 222 may also include all or a portion of the AR application 220 that is executed on the computing device 202 to generate 3D scenes, audio signals, and/or video signals. In some implementations, device 202 may generate AR content using AR content generator 262.

The network 208 may be the Internet, a local area network (LAN), a wireless local area network (WLAN), and/or any other network. A computing device 202, for example, may receive the audio/video signals, which may be provided as part of AR content in an illustrative example implementation, via the network 208.

The systems described herein can include systems that insert computer-generated content into a user's perception of the physical space surrounding the user. The computer-generated content may include labels, textual information, images, sprites, and three-dimensional entities. In some implementations, the content is inserted for entertainment, educational, or informational purposes.

Although many examples described herein relate to AR systems inserting and/or compositing visual content into an AR environment, content may be inserted using the techniques described herein in other systems too. For example, the techniques described herein may be used to insert content into an image or video.

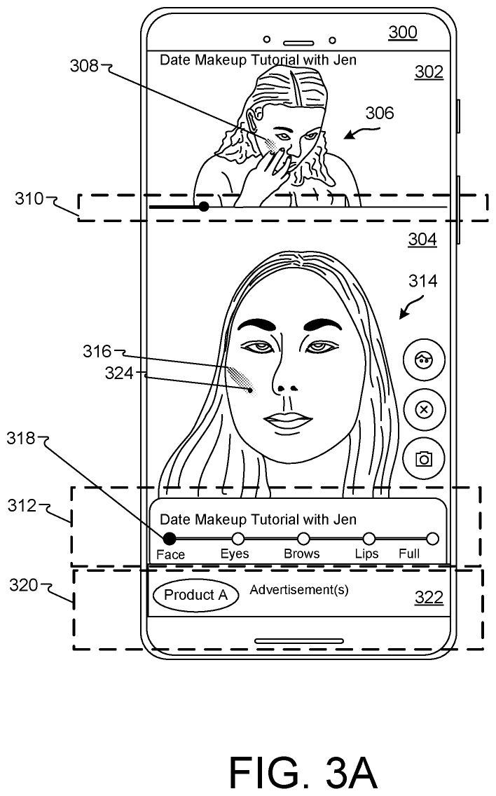

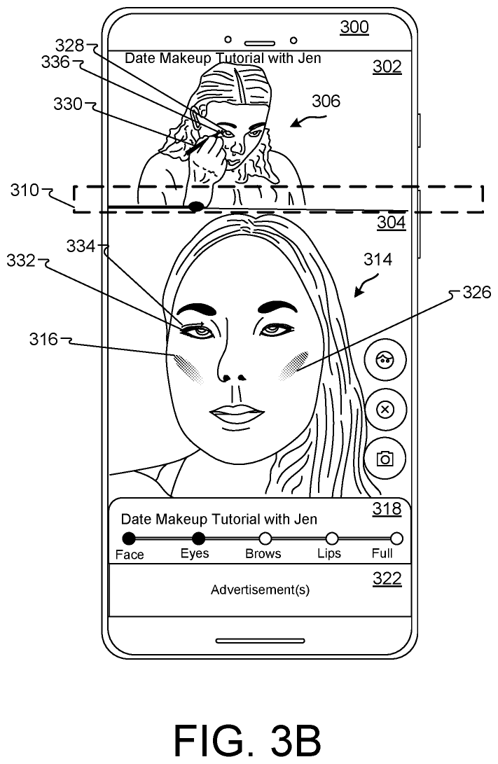

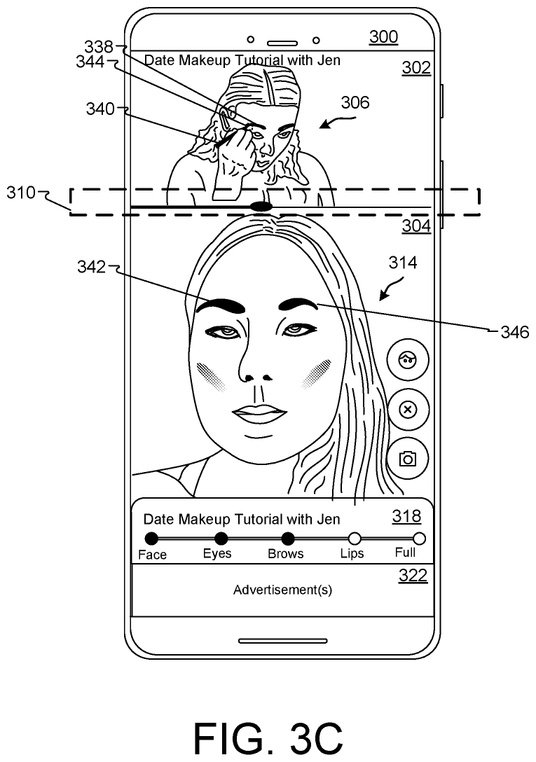

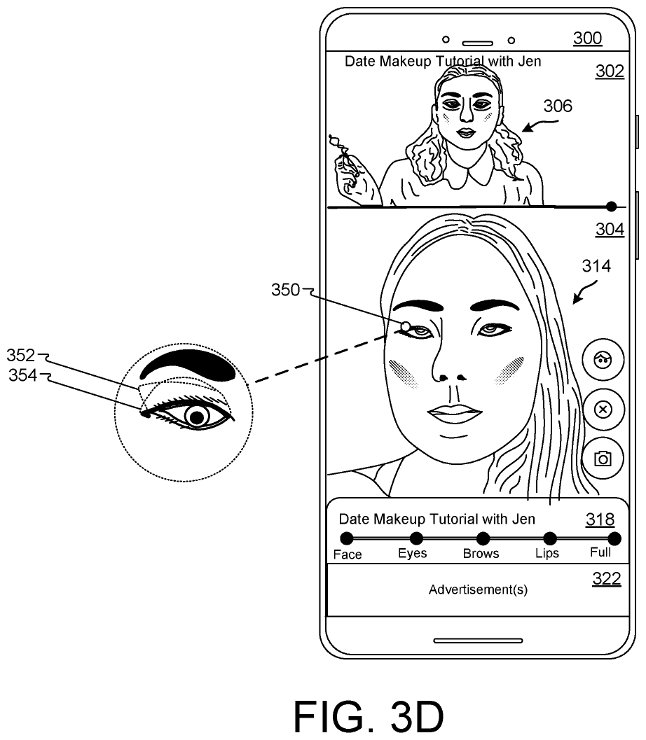

FIGS. 3A-3D depict an example illustrating extraction and modification of instructional content for overlay onto live image content presented in an AR experience, according to example implementations. The examples depicted below enable a user to experience a makeover with a content creator as well as to save products for purchase and save images for later retrieval and/or sharing. That is, the user may learn the techniques by watching the makeup be applied to their own face using AR makeup content overlaid onto a live feed of the face of the user. While the examples describe tutorials (e.g., instructional content 204) for application of makeup products, any instructional content (e.g., images, image frames, videos, etc.) may be substituted to carry out instructions extracted from the instructional content.

In this example, a user may access instructional content such as images, step-by-step tutorials, and/or video content online. The instructional content may be provided to a user with options to experience the instructional content on a live feed of the user. The instructional content may be adapted to be used to generate AR content to mimic the end result of the instructions of the instructional content. Tools, body parts, and other interfering image content may be removed from such end results in order to apply the end result (or show intervening steps) to an object in a live feed. For example, if a makeup tool is used to apply makeup, the instructional content may be generated to be able to remove the makeup tool (and/or a hand using the tool). Such techniques may include use of tracking, green screen techniques, and/or other object removal techniques.

As shown in FIG. 3A, mobile device 300 is accessing a first media content item (such as an instructional video 302) while a second video content item (e.g., a live camera feed 304) is captured (i.e., capturing live content) and displayed with the video 302. As shown in this example, the video 302 depicts a user 306 carrying out instructional content. In this example, the instructional content includes applying makeup to the face of user 306, as shown by a hand applying makeup 308. In some implementations, the media content (e.g., instructional video 302) may not be shown to the user, for example, to improve the learning experience of viewing the instructions with respect to the user's live feed 304. For example, the instructions and instructional content may be depicted on the live feed 304 and video 302 may not be shown to the user during particular time periods throughout the video 302.

The video 302 includes a timeline 310. The timeline 310 is associated with a plurality of timestamps that correspond to video frames of the video 302. In some implementations, the timeline 310 may be synchronized to a timeline (e.g., timeline 312) in another media content item (e.g., live feed 304). The synchronization may enable the user to follow different steps in the tutorial to learn how to apply the instructions (e.g., apply the makeup) at a particular time. Synchronizing timeline 310 to the timeline 312 can allow the user 314 to experience application of makeup (e.g., AR content 316) at the same time as user 306 is applying the same makeup 308 (e.g., motions of application and resulting color) in a corresponding face location on the face of user 306. That is, user 314 may simultaneously view AR makeup content being applied to her face in feed 304 (e.g., as an overlay of AR content) while viewing the technique shown in video 302.

The timeline 312 depicts a number of trackable objects from the live feed 304 which may correspond to particular segments of video 302. In this example, the timeline 312 corresponds to content 302 (e.g., “Date Makeup Tutorial with Jen”) and includes timeline 318 sections of video corresponding to application of makeup to the face, eyes, brows, lips, and final full makeup look.

The instructional content of video 302 may also include corresponding timeline synchronized product lists 320 that provide purchase options and advertising 322 for particular products used in the video 302. In some implementations, the advertisements 322 may also include related instructional content from any number of video content authors, for example. In some implementations, affiliate links and/or fallback affiliate links may be provided in advertisements 322.

In operation of system 200, the user 314 of device 300 may access video 302 while capturing herself with a front-facing camera (e.g., camera assembly 236) to begin an AR experience with AR application 220, for example. In this example, the user 314 may be accessing a camera assembly 236 in sensor system 216, computer vision (CV) system 228, and tracking system 238, which may work together to provide software and algorithms that track, generate, and place AR content around captured image feed 304 (e.g., live and real time).

For example, the computing device 300 can detect that instructional content item 302 is being accessed and that the user is capturing a feed 304. Both content 302 and feed 304 may be depicted on device 300 to allow the user to learn the instructional content from video 302 using the face belonging to the user 314, in this example. The device 300 may include or have access to a computer vision system 228, which can detect elements, objects, or other details in video 302 and/or feed 304. The detected elements and/or objects may represent portions of video 302 to be modified for use in generating AR content 222, which may be overlaid onto feed 304. Tracking system 238 can assist the computer vision system 228 to extract and modify particular content 302. AR application 220 may assist in modifying and rendering AR content 222 on device 300.

In some implementations, additional UI elements can be generated to assist the user in learning and applying the techniques of video 302. For example, the UI content generator 260 and/or AR content generator 262 may work alone or together to generate gleams, such as gleam 324 to indicate to the user (on her own face, body, etc.) where to place makeup, in this example. Other examples can use gleams to indicate where to begin or end an instruction for a tutorial. For example, if a particular tutorial teaches a bicep curl, a gleam may be placed on the wrist of a user in a live feed to indicate to the user where to begin and end the bicep curl. Once the user moves the marked wrist into or out of a gleam position, the user may begin to understand the intended movement of the bicep curl and may learn muscle memory for where to begin and end the bicep curl movement. In some implementations, other UI elements may be used including, but not limited to arrows, lighting elements, graphics, animations, text for supplemental information, and/or other AR content that may be overlaid on a video or image stream such that the UI elements assist the user in learning a new technique, craft, skill, hobby, etc. As used herein, a gleam may be a UI element representing an AR object. Gleams may also be referred to as a dot, an affordance, and the like. Any shape or object may represent a gleam including both visible and invisible elements within a user interface.

In some implementations, the UI content generator 260 can also remove content from an object (e.g., a face) in a content item. For example, the UI content generator 260 can determine that a user in a live feed is currently wearing makeup and such makeup should be digitally removed in order to overlay the content and correctly capture the look of the overlaid content. In such examples, the UI content generator 260 in combination with the computer vision system 228 may remove portions of images from the video by extracting the elements and providing new content as overlay over the extracted elements.

Referring to FIG. 3B, the face makeup applied in FIG. 3A is completed, as shown by AR content 316 and AR content 326. According to timeline 318, video 302 is now providing instructions for applying eye makeup. In particular, eyeliner 328 from video 302 is being applied with an eyeliner tool 330. At the same time, the live feed 304 of user 314 is now depicting an overlay of AR content (e.g., eyeliner 332) which is applied in a motion with respect to tool 330, as shown by arrow 334. The timeline 318 has been updated to indicate that the eyes are being worked on, which correlates to timeline 310 (FIG. 3B).

In some implementations, preprocessing may be performed on particular segments, objects, tools, or other elements in a media content item in order to properly overlay such content on another content item. For example, a bounding box 336 and/or other tracking algorithm may be used by computer vision system 228 to ensure that the eyeliner path 328 may be tracked and reproduced as AR content 334 for applying eyeliner 332 on user 314. For example, a moving object detection may include techniques such as background subtraction, frame differencing, temporal differencing, and optical flow, any and all of which may be used for object tracking. A bounding box and/or path can be drawn using the tracked object.

In operation, the system 200 may obtain segments of a first media content item. For example, the computer vision system 228 may obtain segments associated with video 302. The segments may be preconfigured, preprocessed, or may be obtained and processed by system 200. The segment detector 252 may analyze or otherwise determine how segments may be used in system 200. The content extraction engine 250 may then extract, from a first segment, a number of image frames. The image frames may pertain to a particular set of instructions, which in this example, may pertain to image frames showing motions (e.g., tracked movements) and color that depict application of eyeliner 328 using tool 330.

The content extraction engine 250 may also extract a second segment from the segments of the first media content item (e.g., video 302). The second segment may have a timestamp that occurs after the first segment, which is after the extracted image frames associated with the tracked movements. In particular, the second segment may pertain to a visual result (e.g., applied eyeliner) associated with the eye of the user 306.

The computer vision system 228 may compare the image frames from the first segment to tracked objects in a second media content item (e.g., live feed 304). For example, the system 228 may use face tracking software 264 and/or object tracking software 266 to perform comparisons between the image frames of the first segment (of video 302) with tracked objects (e.g., the eye in live feed 304).

The computer vision system 228 may utilize content detector 251 and software 264 and/or software 266 to detect that at least one of the tracked objects (e.g., the face, eye of the user 314) in the second media content item (e.g., video 304) is similar to at least one feature (e.g., the face, eye of the user 306) in image frames associated with the first media content item (e.g., video 302). In some implementations, the object tracking software 266 (or face tracking software 264) may use optical flow computer vision techniques (or another moving object detection technique) to track steps within instructional content.

The system 200 may then use the extracted image frames (from video 302) and at least one image frame from the second segment (e.g., result(s) shown in video 302) to generate virtual content that includes at least a portion of the image frames that depict the tracked movements from the first segment being performed on (e.g., overlaid on top of) the at least one tracked object (e.g., eye of user 314) and depict at least one image frame (the result(s) shown in video 302) from the second segment on the at least one tracked object (e.g., eye of user 314). In short, the UI content generator 260 and/or AR content generator 262 may use image frames from video 302 to generate AR content 222 (e.g., eyeliner motions and color) for overlay on the eye of user 314 to provide an AR experience for user 314 that includes application of instructive makeup tutorial of video 302 on the actual eye/face of user 314, as depicted in the live feed video 304. In some implementations, the AR content may be overlaid on top of a static image (e.g., an image captured during or before the user utilized the overlay feature). Upon completing the generation of the AR content 222 (e.g., the eyeliner motions and color), the render engine 230 may trigger rendering of the virtual content (e.g., AR content 222) as an overlay on the at least one tracked object (e.g., eye of user 314) in the second media content item (e.g., live feed 304).

Referring to FIG. 3C, the eyeliner makeup applied in FIG. 3B is completed and shown on both eyes of user 314. According to timeline 318, video 302 is now providing instructions for applying eyebrow makeup. In particular, eyebrow makeup 338 from video 302 is being applied with an eyebrow tool 340. At the same time, the live feed 304 of user 314 is now depicting an overlay of AR content (e.g., eyebrow makeup 342) which is applied in a motion with respect to tool 340, as shown by motion 344. The timeline 318 has been updated to indicate that the eyebrows are being worked on, which correlates to timeline 310 (FIG. 3C). In some implementations, the timeline 318 may depict makeup steps that the user selected. For example, other portions of the video 302 may not be played if the user did not select such other portions. For example, a user may like the face and brow steps, but not the eye makeup from this video 302 (or the user may already be wearing eye makeup and may wish to test new styles for other makeup).

Eyebrow 346 has yet to be completed, but the same process may be followed with user 306 carrying out instructions on user 306 eyebrows while system 200 generates AR content 222 to mimic the movements and applied eyebrow makeup on brow 346 of user 314. In some implementations, additional AR content or UI content may be added to assist the user. For example, annotations may be depicted on the objects in video 302 to indicate which products have been used on the objects. In particular, an annotation (not shown) may be generated by UI content generator 260 based on the computer vision system 228 recognizing a product and/or color of the product from video 302. The recognized product and/or color may be used to generate annotations for depiction over video 302 and/or depiction on objects within live feed 304.

In some implementations, additional videos, images, or other content may be provided based on analysis performed by the computer vision system 228 on content in the live feed 304. For example, with user set permissions, the user may be provided additional content for related instructional content pertaining to other objects in the live feed, such as hair, skin, eyelashes, eyebrows, face shape, clothing, etc. In some implementations, the user may trigger a search using the live feed such as find videos that are like my hair to be provided instructional content to style hair similar to the hair of user 314.

Referring to FIG. 3D, a full makeup look is shown complete according to timeline 318 of live feed 304 and according to completion of video 302. In some implementations, additional UI content may be provided to allow users to find additional help and/or instruction. Similarly, additional UI content may be provided to allow for modifications of instructions in video 302 to be performed for a particular shape of a feature of the user in live feed 304. In the depicted example of FIG. 3D, the user is provided additional templates to select a different eyeshadow and/or eyeliner contour than is depicted in instructional content of video 302 to account for a different shape/age of the eye of user 314 or to simply provide additional options according to user preferences. In particular, a UI element 350 is provided that the user may select upon to view additional contour selections. A first contour 352 and a second contour 354 are provided for selection. Additional shapes, sizes, contours, and UI elements may be provided and are not shown here for the sake of simplicity.

The user may select upon one of the offered contours 352, 354 to re-run the eye portion of video 302 and have the AR content 222 (e.g., eyeliner, eyeshadow, eyebrow makeup, etc.) reapplied according to the updated selection. Similar offerings can be provided to change the color, thickness, and/or other visual effect of the makeup application. In effect, the user may work to customize the application of AR content on the face of the user based at least in part on the original content in an instructional video.

In some implementations, UI elements such as UI element 350 may be provided as a mark (or other element) that may be overlaid onto the user's own facial features to assist the user to learn the techniques in the video 302. For example, if UI element 350 is overlaid on the waterline of the eye, the UI element 350 may be adapted to move along the waterline to show an exact placement for the user to place eyeliner, in this example.

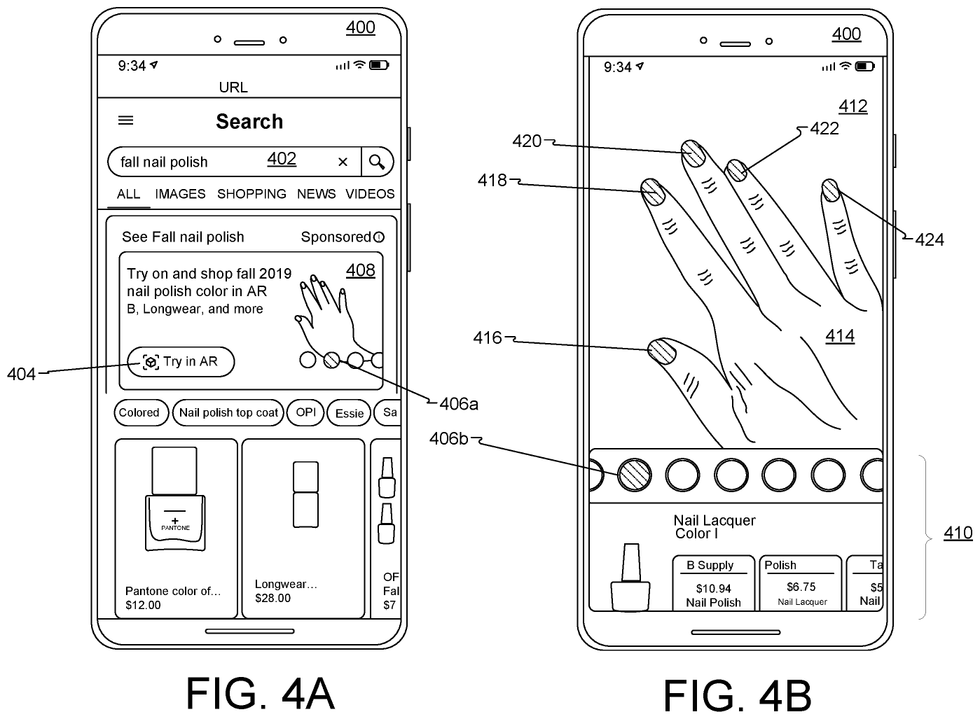

FIGS. 4A-4B depict another example illustrating extraction and modification of instructional content for overlay onto live image content presented in an AR experience, according to example implementations. In this example, a user may access instructional content showing a manicure and application of a nail polish color.

As shown in FIG. 4A, a user may be accessing computing device 400 to perform a search for new Fall nail polish, as shown by search 402. The search engine has provided a result to “Try in AR,” as shown by button 404. The user may view content/image 408 and may select a color 406a and then select the button 404 to try the color in a live feed using the user's own hand. This may provide an advantage of allowing the user to shop and try on different nail colors using a search engine without having to go to a brick and mortar store to swatch the colors on the hand of the user. The content can include steps to create particular nail art.

As shown in FIG. 4B, the system 200 has triggered opening of AR application 220 to show content 410, which illustrates nail colors, the user's selected color 406b and other nail polish options. Opening the AR application 220 may also trigger the live camera feed 412, which depicts the user's hand 414. When the user clicks the color 406b, the fingernails 416, 418, 420, 422, and 424 may be automatically overlaid with the color 406b, as retrieved from image 406a.

In this example, the computer vision system 228 may detect landmark content (e.g., fingernails shown in content/image 408) using content detector 251 and may then use a content extraction engine to obtain image frames showing portions of the detected landmark content. The computer vision system 228 may use an algorithm to detect and extract similar content from live feed 412 to find content similar to the landmark content. An image swapping technique may be used to map the landmark content of the first image 408 to the similar content shown in feed 412. The mapped content can be applied as an overlay in the live feed 412, as shown by color 406a being applied to fingernails 416-424.

In some implementations, product information can be extracted from the image processing steps described herein. Given a high confidence score from a computer vision algorithm, AR application 410 may include information on the relevant product(s) and other similar, related, and/or complementary products.

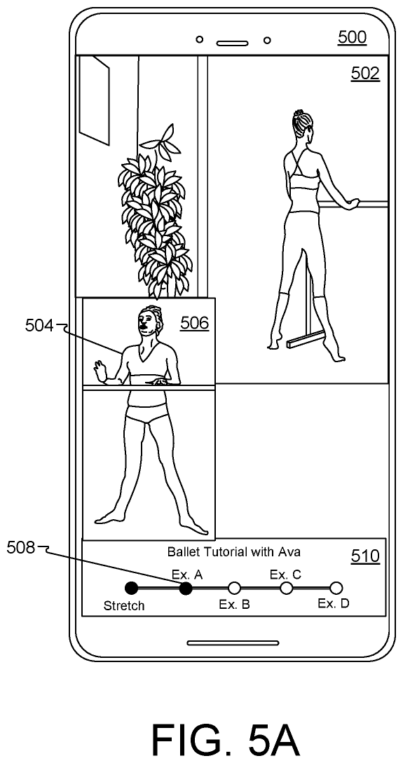

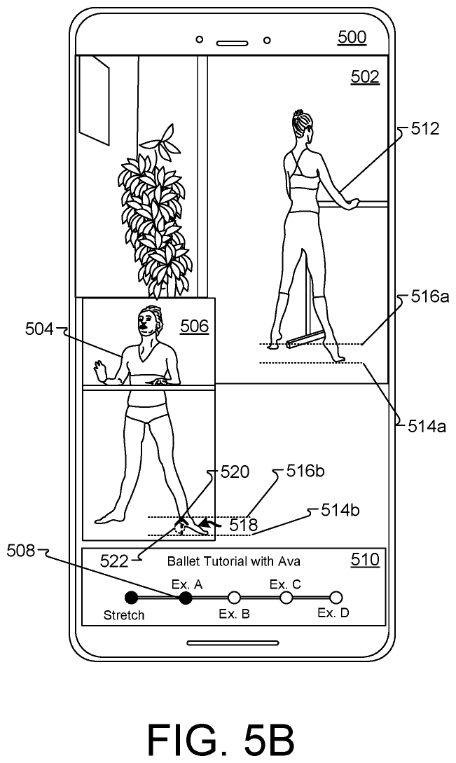

FIGS. 5A-5B depict yet another example illustrating extraction and modification of instructional content for overlay onto live image content presented in an AR experience, according to example implementations. This example depicts a user learning instructional content pertaining to ballet. The same algorithms and techniques described herein may be applied to other sports and movements to enable the user to learn additional skills.

As shown in FIG. 5A, a user is accessing mobile device 500 to access instructional ballet video content 502. At the same time, a front facing camera of device 500 may be capturing such a user (e.g., user 504) within feed 506. In operation, the computing device 500 (e.g., computing device 202) can detect (or be provided indications) that instructional content item 502 is being accessed and that the user 504 is capturing the feed 506. Both content 502 and feed 506 may be depicted on device 500 (e.g., device 202) to allow the user 504 to learn the instructional content 502 on the body portions belonging to the user, as shown by captured user 504 in the feed 506, in this example. Here, the instructional content 502 includes a user performing an exercise A 508 (shown by timeline 510) to raise her heels from the floor.

The device 500 (e.g., device 202) may include or have access to the computer vision system 228, which can detect the instructional content 502 (e.g., actions, movements, modification of objects, body features, etc.) or other details in content item 502. The instructional content (e.g., ballet exercise movements) and resulting output of such movements (e.g., lifting the heels of the user from the floor) may be detected, extracted, and/or otherwise analyzed.

As shown in FIG. 5B, the computer vision system 228 may track movement within content 502 and may detect that the user 512 from content 502 is moving her feet and may detect that the particular movement occurs from a location 514a to a location 516a. The detected movement may trigger content extraction engine 250 to extract the particular video segment that includes the feet movement and in particular to extract image frames associated with the tracked movements. In addition, a final pose (e.g., result) of the movement may be determined and a second video segment that depicts the result of the final pose. In general the result is depicted after the movement and as such, the timestamp of the result is after the timestamp of the segment that includes the tracked movements.

In order to show the instructional content (e.g., ballet foot movements) on the user 504 in feed 506, the computer vision 228 may compare the extracted image frames from the video 502 with tracked objects (e.g., the feet of user 504) in the feed 506. In response to detecting that at least one of the tracked objects (e.g., user foot 518) in the second media content item (e.g., feed 506) is similar to at least one feature (e.g., the foot of user 512) in the extracted image frames, the UI content generator 260 and/or the AR content generator 262 can generate using the extracted plurality of image frames (e.g., the foot of user 512) and at least one image frame (e.g., final foot pose result) from the second segment, virtual content that includes at least a portion of the image frames depicting the plurality of tracked movements (e.g., foot raise) from the first segment (e.g., video 502) being performed on the at least one tracked object (e.g., foot 518) and depicts the at least one image frame from the second segment on the at least one tracked object. In this example, the instructional content may include elements 516a and 516b to show the user how high the heel should be raised. As such, AR content generator 262 may generate resulting elements 514b and 516b to depict that the user 506 has not yet raised her heels high enough. Alternatively, the user 506 may have surpassed the distance between elements 514a and 516a and as such, elements 514b and 516b may then show the user that additional difference between the lines. In short, the elements 514b and 516b may be used to ensure the user 506 is using the correct form as being taught in video 502 on user 512. The feedback can also be in the form of audio (text-to-speech), sound, haptic, and other types of feedback.

Additional UI content may be shown. For example, UI content generator 260 depicted that the user 506 has not yet raised her heel high enough, as indicated by AR element 516b and arrow element 520. Arrow element 520 may indicate to the user that she may need to raise her heel to reach AR element 516b to properly perform the instructions being taught in video 502. In some implementations, additional elements, such as gleam 522 may be provided to trigger the user to look at a particular element (e.g., the heel in this example) of the feed 506.

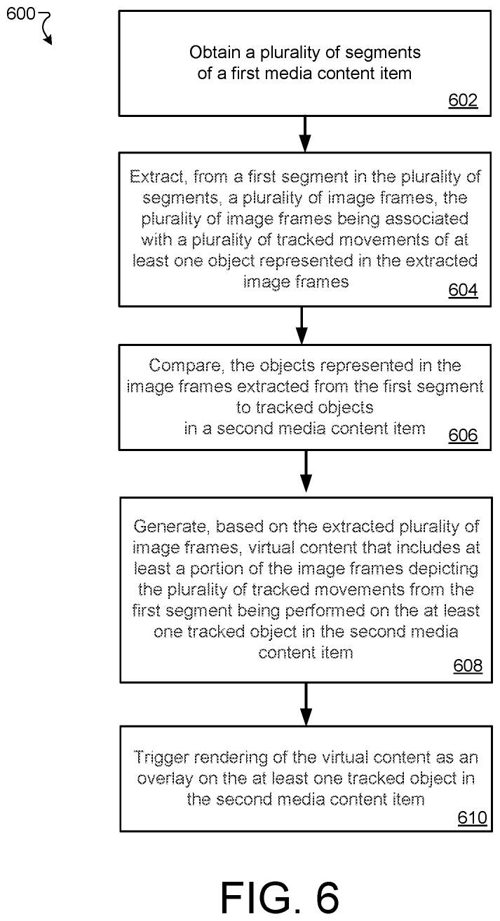

FIG. 6 is an example process 600 to analyze image content for use in generating layered augmented reality content, according to example implementations. The process 600 may be a computer-implemented method and is described with respect to an example implementation of the electronic device described in FIGS. 1, 2, 3A-3D, and/or system 700, but it will be appreciated that the process 600 can be implemented by devices and systems having other configurations. In this example, the user 314 may be accessing a camera assembly 236 in sensor system 216, computer vision (CV) system 228, and tracking system 238, which may work together to provide software and algorithms that track, generate, and place AR content around captured image feed 304 (e.g., live and real time).

At block 602, the process 600 includes obtaining a plurality of segments of a first media content item. For example, the computing device 202 may access instructional content 204 over network 208. The instructional content 204 may include any number of segments of images, video, image frames, etc. The AR application 220 may use computer vision system 228 to obtain the segments of a video (e.g., instructional content 204) accessed with device 202.

As used herein, a media content item may represent any or all of an image, a plurality of images, an image frame, a plurality of image frames, a document file, a video file, an audio file, an image or video segment, and/or an image or video clip.

At block 604, the process 600 includes extracting, from a first segment in the plurality of segments, a plurality of image frames in the first media content item. For example, the content extraction engine 250 may use content detector 251 to detect a first segment and extract the plurality of image frames from the first segment in the first media content item. In general, the plurality of image frames may be associated with a plurality of tracked movements of the at least one object represented in the extracted image frames, which may be provided as information about the movements (e.g., timestamps, metadata, etc.) within the content and/or may be detected as tracked movements within the content (using tracking system 238), for example.

At block 606, the process 600 includes comparing, objects represented in the image frames extracted from the first segment to tracked objects in a second media content item. For example, the content detector 251 may use the extracted image frames from the first media content item (e.g., video 302 in FIG. 3C) as a comparison basis for finding tracked objects (e.g., eyebrow 342 of the user 314 in FIG. 3C) in the second media content item (e.g., live video feed 304). In operation of system 200, the user 314 of device 300 may access instructional content (e.g., video 302) while capturing herself with a front-facing camera (e.g., camera assembly 236) to begin an AR experience with AR application 220, for example. In some implementations, the process 600 may include obtaining and/or creating mesh (face or body) data of the user before accessing video content in order to improve mesh morphing from the instructional content onto the user/object, etc.

The comparisons performed by process 600 may include segment detection (using segment detector 252), lighting estimations (using lighting estimator 258), face tracking software 264, and/or object tracking software 266 to carry out analysis for features in the first media content item (e.g., content 302) as compared to tracked objects in the second media content item (e.g., video 304)

In some implementations, the image capture device (e.g., camera assembly 236) associated with a computing device 202 may perform extractions and comparisons for each of the segments and any number of the plurality of frames from the segments in order to generate additional AR content for overlay onto the second media content item (e.g., video 304). For example, for each timestamp pertaining to objects such as face, eyes, brows, lips, and full makeup in timeline 318 may have corresponding and comparable content with segments in video 302.

In general, the computing device 202 can detect that instructional content item 302 is being accessed and that the user is capturing a feed 304. Both content 302 and feed 304 may be depicted on device 300 to allow the user to learn the instructional content from video 302 using the face belonging to the user 314, in this example. The device 202 may include or have access to a computer vision system 228, which can detect elements, objects, or other details in video 302 and/or feed 304. The detected elements and/or objects may represent portions of video 302 to be modified for use in generating AR content 222, which may be overlaid onto feed 304. Tracking system 238 can assist the computer vision system 228 to extract and modify particular content 302. AR application 220 may assist in modifying and rendering AR content 222 on device 202.

At block 608, the process 600 includes generating, based on (e.g., and/or using) the extracted plurality of image frames, virtual content (e.g., AR content 222) depicting the plurality of tracked movements (from the first segment) being performed on the at least one tracked object (e.g., the eyebrow 342) in the second media content item. Generating such virtual content may be performed in response to detecting that at least one of the tracked objects (e.g., eyebrow 342) in the second media content item (e.g., video feed 304) is similar to at least one object (e.g., eyebrow 338) in the plurality of extracted image frames (e.g., from video 302). In some implementations, detecting that the at least one tracked object (e.g., eyebrow 342) in the second media content item (e.g., video feed 304) is similar to the at least one object (e.g., eyebrow 338) in the first media content item (e.g., video 302) includes comparing a shape of the at least one tracked object to the shape of the at least one feature (comparing eye, eyebrow shapes). In some implementations, the generated virtual content is depicted on the at least one tracked object according to the shape of the feature(s) and or according to other aspects of the feature(s).

At block 610, the process 600 includes triggering rendering of the virtual content as an overlay on the at least one tracked object in the second media content item. For example, the completed overlay of AR content is shown on eyebrow 342 which shows a result of application of eyebrow makeup using tool 340. The eyebrow 346 has yet to be completed and thus no overlay of AR content is depicted until FIG. 3D, which shows both eyebrows completed. In some implementations, triggering rendering of the virtual content as an overlay on the at least one tracked object in the second media content item includes synchronizing the rendering of the virtual content on the second media content item with a timestamp associated with the first segment. For example, the two content items 302 and 304 may be synchronized to apply makeup (e.g., content) from video 302 to the user 314 in the live feed of video feed 304.

In some implementations, the steps described above may be configured for system 200 to cause the at least one processor assembly 212 to perform the steps for each of the obtained plurality of segments of the first media content item. For example, each of the steps in blocks 602 to 610 may be performed for each of the plurality of segments.

In some implementations, a second segment from the first media content item may be extracted from the plurality of segments. The second segment may have a timestamp after the first segment. For example, the second segment may depict a visual result of the tracked movements occurring in one or more of the image frames of the first segment. The visual result may be associated with the at least one object in the plurality of extracted image frames and the tracked movements. For example, the visual result may be the completed eyebrow makeup 338 of user 306 which may be extracted from the image frames in the second segment. At least one of the extracted image frames of the second segment (e.g., an image frame that includes completed eyebrow 338) may be used by system 200 to generate the virtual content (e.g., the eyebrow overlay 342), which may be used to depict the at least one image frame from the second segment on the at least one tracked object (e.g., the eyebrow of user 304).

In some implementations, the system 200 includes a computer vision system (e.g., system 228) to analyze the first media content item (e.g., video 302) to determine which of the plurality of segments to extract and which of the plurality of image frames to extract. The computer vision system 228 may also be used to analyze the second media content item (e.g., video feed 304) to determine which object (e.g., eyebrow 342) corresponds to the at least one object (e.g., eyebrow 338) in the extracted image frames of the first media content item (e.g., video 302).

In some implementations, the plurality of tracked movements correspond to instructional content in the first media content item and the plurality of tracked movements are depicted as the virtual content (e.g., AR content 222 as eyebrow 342). The virtual content may also include motions that illustrate performance of the plurality of tracked movements on the at least one tracked object in the second media content item. For example, the AR content 222 may include application of the makeup to the eyebrows of user 314 and an end result as the AR overlay completed as eyebrow 342 shown in FIG. 3C.

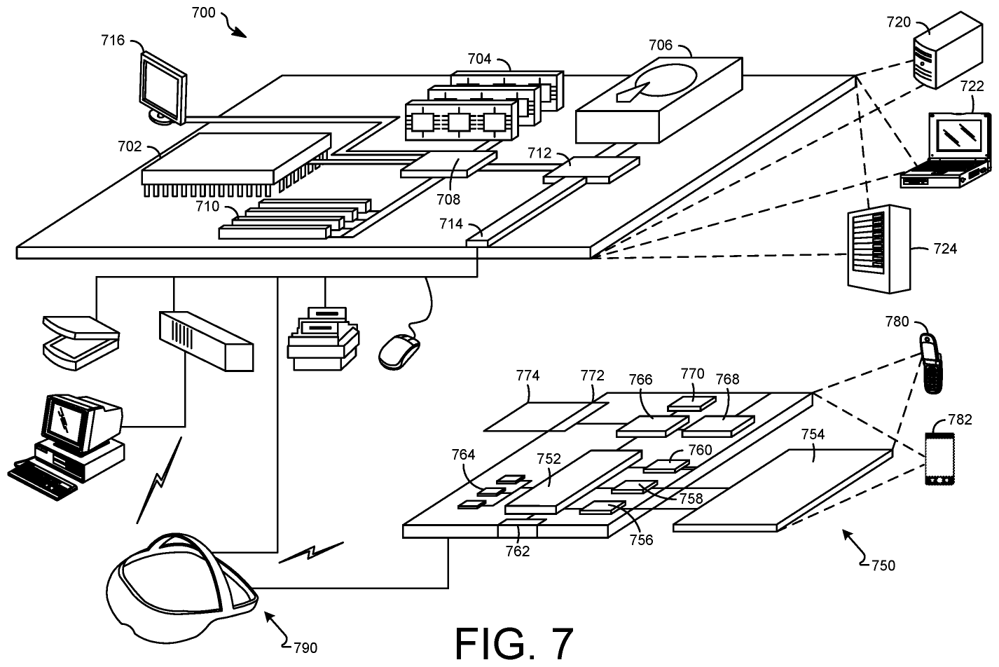

FIG. 7 shows an example computer device 700 and an example mobile computer device 750, which may be used with the techniques described here. In general, the devices described herein can generate and/or provide any or all aspects of a virtual reality, an augmented reality, or a mixed reality environment. Features described with respect to the computer device 700 and/or mobile computer device 750 may be included in the portable computing device 102 and/or 202 described above. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the systems and techniques claimed and/or described in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of functions is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display) or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provided in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provided as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752, that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, Wi-Fi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smart phone 782, personal digital assistant, or other similar mobile device.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a standalone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, LED display, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a backend component, e.g., as a data server, or that includes a middleware component, e.g., an application server, or that includes a frontend component, e.g., a client computer having a graphical user interface or a Web browser through which a user can interact with an implementation, or any combination of such backend, middleware, or frontend components. Components may be interconnected by any form or medium of digital data communication, e.g., a communication network. Examples of communication networks include a local area network (LAN) and a wide area network (WAN), e.g., the Internet.

The computing device based on example embodiments described herein may be implemented using any appropriate combination of hardware and/or software configured for interfacing with a user including a user device, a user interface (UI) device, a user terminal, a client device, or a customer device. The computing device may be implemented as a portable computing device, such as, for example, a laptop computer. The computing device may be implemented as some other type of portable computing device adapted for interfacing with a user, such as, for example, a PDA, a notebook computer, or a tablet computer. The computing device may be implemented as some other type of computing device adapted for interfacing with a user, such as, for example, a PC. The computing device may be implemented as a portable communication device (e.g., a mobile phone, a smart phone, a wireless cellular phone, etc.) adapted for interfacing with a user and for wireless communication over a network including a mobile communications network.

The computer system (e.g., computing device) may be configured to wirelessly communicate with a network server over a network via a communication link established with the network server using any known wireless communications technologies and protocols including radio frequency (RF), microwave frequency (MWF), and/or infrared frequency (IRF) wireless communications technologies and protocols adapted for communication over the network.

In accordance with aspects of the disclosure, implementations of various techniques described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

Specific structural and functional details disclosed herein are merely representative for purposes of describing example embodiments. Example embodiments, however, may be embodied in many alternate forms and should not be construed as limited to only the embodiments set forth herein.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” “before,” “after,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 70 degrees or at other orientations) and the spatially relative descriptors used herein may be interpreted accordingly.

Example embodiments of the concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example embodiments.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

Unless otherwise defined, all terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

In addition, the logic flows depicted in the figures may be performed in the particular order shown, or sequential order, to achieve desirable results. In some implementations, the logic flows depicted in the figures may not be performed in the particular order shown and may instead be performed in a different order. In addition, other steps may be provided, or steps may be eliminated, from the described flows, and other components may be added to, or removed from, the described systems. Accordingly, other embodiments are within the scope of the following claims.

What is claimed is:

1. A computer-implemented method carried out by at least one processor, the method comprising:
obtaining a plurality of segments of a first media content item;
extracting, from a first segment in the plurality of segments, a plurality of image frames, the plurality of image frames being associated with a plurality of tracked movements of at least one object represented in the extracted image frames;
comparing, objects represented in the image frames extracted from the first segment to tracked objects in a second media content item;
in response to detecting that at least one of the tracked objects in the second media content item is similar to at least one object in the plurality of extracted image frames, generating, based on the extracted plurality of image frames, virtual content depicting the plurality of tracked movements from the first segment being performed on the at least one tracked object in the second media content item; and
triggering rendering of the virtual content as an overlay on the at least one tracked object in the second media content item.

2. The method of claim 1, further comprising:
extracting, from the plurality of segments, a second segment from the first media content item, the second segment having a timestamp after the first segment; and
generating, using the extracted at least one image frame from the second segment of the first media content item, virtual content that depicts the at least one image frame from the second segment on the at least one tracked object in the second media content item.

3. The method of claim 2, wherein the at least one image frame from the second segment depicts a visual result associated with the at least one object in the extracted image frames.

4. The method of claim 1, wherein a computer vision system is employed by the at least one processor to:
analyze the first media content item to determine which of the plurality of segments to extract and which of the plurality of image frames to extract; and
analyze the second media content item to determine which object corresponds to the at least one object in the plurality of extracted image frames of the first media content item.

5. The method of claim 1, wherein the detecting that the at least one tracked object in the second media content item is similar to the at least one object in the plurality of extracted image frames includes comparing a shape of the at least one tracked object to the shape of the at least one object in the plurality of extracted image frames, and wherein the generated virtual content is depicted on the at least one tracked object according to the shape of the at least one object in the plurality of extracted image frames.

6. The method of claim 1, wherein triggering rendering of the virtual content as an overlay on the at least one tracked object in the second media content item includes synchronizing the rendering of the virtual content on the second media content item with a timestamp associated with the first segment.

7. The method of claim 1, wherein:
the plurality of tracked movements correspond to instructional content in the first media content item; and
the plurality of tracked movements are depicted as the virtual content, the virtual content illustrating performance of the plurality of tracked movements on the at least one object in the plurality of extracted image frames in the second media content item.

8. A system comprising:
an image capture device associated with a computing device;
at least one processor; and
memory storing instructions that, when executed by the at least one processor, cause the system to:
obtain a plurality of segments of a first media content item;
extract, from a first segment in the plurality of segments, a plurality of image frames, the plurality of image frames being associated with a plurality of tracked movements of at least one object represented in the extracted image frames;
compare, objects represented in the image frames extracted from the first segment to tracked objects in a second media content item;
in response to detecting that at least one of the tracked objects in the second media content item is similar to at least one object in the plurality of extracted image frames, generating, based on the extracted plurality of image frames, virtual content depicting the plurality of tracked movements from the first segment being performed on the at least one tracked object in the second media content item; and
trigger rendering of the virtual content as an overlay on the at least one tracked object in the second media content item.

9. The system of claim 8, further comprising:
extracting, from the plurality of segments, a second segment from the first media content item, the second segment having a timestamp after the first segment; and
generating, using the extracted at least one image frame from the second segment of the first media content item, virtual content that depicts the at least one image frame from the second segment on the at least one tracked object in the second media content item.

10. The system of claim 9, wherein the at least one image frame from the second segment depicts a visual result associated with the at least one object in the extracted image frames.

11. The system of claim 8, wherein the system further includes a computer vision system employed by the at least one processor to:
analyze the first media content item to determine which of the plurality of segments to extract and which of the plurality of image frames to extract; and
analyze the second media content item to determine which object corresponds to the at least one object in the plurality of extracted image frames of the first media content item.

12. The system of claim 8, wherein the detecting that the at least one tracked object in the second media content item is similar to the at least one object in the plurality of extracted image frames includes comparing a shape of the at least one tracked object to the shape of the at least one object in the plurality of extracted image frames, and wherein the generated virtual content is depicted on the at least one tracked object according to the shape of the at least one object in the plurality of extracted image frames.

13. The system of claim 8, wherein triggering rendering of the virtual content as an overlay on the at least one tracked object in the second media content item includes synchronizing the rendering of the virtual content on the second media content item with a timestamp associated with the first segment.

14. The system of claim 8, wherein:
the plurality of tracked movements correspond to instructional content in the first media content item, and
the plurality of tracked movements are depicted as the virtual content, the virtual content illustrating performance of the plurality of tracked movements on the at least one object in the plurality of extracted image frames in the second media content item.

15. A computer readable medium tangibly embodied on a non-transitory computer-readable medium and comprising instructions that, when executed, are configured to cause at least one processor to:
obtain a plurality of segments of a first media content item;
extract, from a first segment in the plurality of segments, a plurality of image frames, the plurality of image frames being associated with a plurality of tracked movements of at least one object represented in the extracted image frames;
compare, objects represented in the image frames extracted from the first segment to tracked objects in a second media content item;
in response to detecting that at least one of the tracked objects in the second media content item is similar to at least one object in the plurality of extracted image frames, generating, based on the extracted plurality of image frames, virtual content depicting the plurality of tracked movements from the first segment being performed on the at least one tracked object in the second media content item; and
trigger rendering of the virtual content as an overlay on the at least one tracked object in the second media content item.

16. The computer readable medium of claim 15, wherein the instructions, when executed, are configured to cause the at least one processor to perform the steps of claim 15 for each of the obtained plurality of segments of the first media content item.

17. The computer readable medium of claim 15, wherein a computer vision system is employed by the at least one processor to:
analyze the first media content item to determine which of the plurality of segments to extract and which of the plurality of image frames to extract; and
analyze the second media content item to determine which object corresponds to the at least one object in the plurality of extracted image frames of the first media content item.

18. The computer readable medium of claim 15, wherein the detecting that the at least one tracked object in the second media content item is similar to the at least one object in the plurality of extracted image frames includes comparing a shape of the at least one tracked object to the shape of the at least one object in the plurality of extracted image frames, and wherein the generated virtual content is depicted on the at least one tracked object according to the shape of the at least one object in the plurality of extracted image frames.

19. The computer readable medium of claim 15, wherein triggering rendering of the virtual content as an overlay on the at least one tracked object in the second media content item includes synchronizing the rendering of the virtual content on the second media content item with a timestamp associated with the first segment.

20. The computer readable medium of claim 15, wherein:
the plurality of tracked movements correspond to instructional content in the first media content item; and
the plurality of tracked movements are depicted as the virtual content, the virtual content illustrating performance of the plurality of tracked movements on the at least one object in the plurality of extracted image frames in the second media content item.
